(19) United States
(12) Patent Application Publication
(10) Pub. No.: US 2020/0369288 A1
(43) Pub. Date: Nov. 26, 2020

(54) METHOD FOR CONSTRUCTING LINEAR LUENBERGER OBSERVER FOR VEHICLE CONTROL

(71) Applicant: BEIJING INSTITUTE OF TECHNOLOGY, Beijing (CN)

(72) Inventors: Hui LIU, Beijing (CN); Hongji SHEN, Beijing (CN); Shengli LI, Beijing (CN); Xiaoyu ZHANG, Beijing (CN); Xiaoxia FENG, Beijing (CN)

(21) Appl. No.: 16/878,729

(22) Filed: May 20, 2020

(30) Foreign Application Priority Data
May 20, 2019 (CN) 201910419584.9

(51) Int. Cl. B60W 50/04; B60W 20/50; G06F 17/16

(52) U.S. Cl. CPC B60W 50/045; B60W 2050/0043; G06F 17/16; B60W 20/50

(57) ABSTRACT

The present invention discloses a method for constructing linear luenberger observer for vehicle control. The method for constructing linear luenberger observer for vehicle control comprises the following steps: step 1: building a state-space equation of a driving system of a vehicle to judge observability of the driving system; step 2: dividing the state of the driving system into blocks, and reconstructing state components of the driving system to obtain an rewritten state observation equation of the driving system; step 3: introducing transformation into the rewritten state equation of the driving system to obtain an expression equation and an error equation of the Luenberger observer. The linear luenberger observer constructed by the present invention has low implementation difficulty. High-frequency noise in an output signal of a rotational speed sensor is reduced.

### TECHNICAL FIELD

The present invention belongs to the field of vehicle control technologies, and in particular relates to a method for constructing linear Luenberger observer for vehicle control.

### BACKGROUND OF THE INVENTION

In view of the cost, the safety and mounting conditions, the existing product-level vehicle is rarely mounted with a torque sensor to directly measure the torque of a drive shaft, but indirectly acquires it through the existing measurable information. Compared with the torque sensor, a rotational speed sensor has low cost. The rotational speed sensor such as a photoelectric coder can be used for monitoring the rotational speed of each element of a power transmission system.

However, the existing method for measuring the torque of the drive shaft is influenced by a rotational speed sensor of a vehicle wheel and an electric motor B rotary transformer error. When an integral method is used for measuring the torque of the drive shaft, sensor signal noises, outside interference and the like may cause accumulation to an estimation result under the action of an integral. Therefore, a large error is generated between an estimation value and an actual value. Especially, when there is an error between an estimation initial value and an actual initial value, an estimation error is increased, so the application difficulty is large in practice.

### SUMMARY OF THE INVENTION

An objective of the present invention is to provide a method for constructing linear Luenberger observer for vehicle control, which feeds back by utilizing actual measurable information and corrects an estimation result in real time such that an estimation value can greatly track an actual value and can resist outside interference to reduce an error between the estimation value and the actual value; at this time, the method is suitable for practical application.

The present invention adopts the following technical solution: a method for constructing linear Luenberger observer for vehicle control specifically comprises the following steps:

step 1: building a state-space equation of a driving system of a vehicle to judge observability of the driving system;

wherein a state equation of the driving system is built by utilizing \dot{θ}_{B}, \dot{θ}ᵥ and Tₛ as state variables, \dot{θ}_{B} and \dot{θ}ᵥ as the output of the driving system, and T_{P} and Tᵥ as the input of the driving system; the state-space equation of the driving system is shown in equation (1):

$$\{ \begin{matrix}\hat{x} = Ax + Bu \\ y = Cx\end{matrix} \qquad ( 1 )$$

wherein x is the input of the state-space equation; y is the output of the state-space equation;

$$x = [ \begin{matrix}{θ}_{1} \\ \text{?} \\ \text{?}\end{matrix} ] , A = [ \begin{matrix}- \frac{\text{?}}{{J}_{P}} & 0 & - \frac{1}{{J}_{p} {i}_{v}} \\ 0 & - \frac{{C}_{v}}{{J}_{v}} & \frac{1}{{J}_{v}} \\ \frac{\text{?}}{\text{?}} - \frac{\text{?}}{\text{?}} & \frac{{C}_{s} {C}_{v}}{{J}_{v}} - \text{?} & - \frac{\text{?}}{{J}_{p} {i}_{r}^{2}} - \frac{\text{?}}{{J}_{v}}\end{matrix} ] , \\ B = [ \begin{matrix}\frac{1}{{J}_{p}} & 0 \\ 0 & - \frac{1}{{J}_{v}} \\ \frac{\text{?}}{{J}_{p} i} & \frac{\text{?}}{{J}_{v}}\end{matrix} ] , C = [ \begin{matrix}1 & 0 & 0 \\ 0 & 1 & 0\end{matrix} ] , u = [ \begin{matrix}\text{?} \\ {T}_{v}\end{matrix} ] ;$$

$$\text{?} \text{indicates text missing or illegible when filed}$$

\dot{θ}_{B} is a rotation angle of an electric motor B; \dot{θ}ᵥ is a rotation angle of a vehicle wheel; θ_{B} is a rotational speed of the electric motor; θᵥ is a rotational speed of the vehicle wheel; \dot{θ}_{B} and θᵥ are obtained by conducting integration on the rotational speeds θ_{B} and θᵥ; Tₛ is a torque of a drive shaft; Cₜ is a damping of a speed reducer; J_{P} is an inertia of a rotor of the electric motor B; iᵣ is a main speed reducer transmission ratio; Cᵥ is a damping of the vehicle wheel; Jᵥ is the sum of an inertia of the vehicle wheel and an equivalent inertia equivalent from a vehicle body to the vehicle wheel; kₛ is a rigidity of the drive shaft; Cₛ is a damping of the drive shaft; i is a transmission ratio of a main speed reducer; T_{P} is a torque of an output shaft of the driving system; Tᵥ is a moment of resistance of a vehicle;

an observability matrix of the driving system is

$$N = [ \begin{matrix}C \\ CA \\ {CA}^{2}\end{matrix} ] ;$$

when a rank of the observability matrix N is 3, the driving system is observable;

step 2: dividing the state of the driving system into blocks, and reconstructing state components of the driving system to obtain a rewritten state observation equation of the driving system;

step 3: introducing transformation into the rewritten state equation of the driving system to obtain an expression equation and an error equation of the Luenberger observer.

Further, step 2 specifically comprises:

the two measurable state variables are the output of the driving system: y=x₁=[θ_{B} θᵥ]^{T}; the state variable Tₛ needs to be observed and is recorded as x₂=[Tₛ]; because the rank of a matrix C is 2, the state-space equation of the driving system is rewritten to be:

$$\{ \begin{matrix}[ \begin{matrix}{\dot{x}}_{1} \\ {\dot{x}}_{2}\end{matrix} ] = [ \begin{matrix}{A}_{11} & {A}_{12} \\ {A}_{21} & {A}_{22}\end{matrix} ] [ \begin{matrix}{x}_{1} \\ {x}_{2}\end{matrix} ] + [ \begin{matrix}{B}_{1} \\ {B}_{2}\end{matrix} ] u \\ y = [ \begin{matrix}I & 0\end{matrix} ] [ \begin{matrix}{x}_{1} \\ {x}_{2}\end{matrix} ] = {x}_{1}\end{matrix} \\ wherein {A}_{11} = [ \begin{matrix}- \frac{{C}_{i}}{{J}_{p}} & 0 \\ 0 & - \frac{{C}_{v}}{{J}_{v}}\end{matrix} ] , {A}_{12} = [ \begin{matrix}- \frac{1}{{J}_{p} i} \\ \frac{1}{{J}_{v}}\end{matrix} ] , \\ {A}_{21} = [ \begin{matrix}\frac{i}{{k}_{s}} - \frac{\text{?}}{{J}_{p} i} & \frac{{C}_{s} {C}_{v}}{{J}_{v}} - {k}_{s}\end{matrix} ] , {A}_{22} = [ - \frac{{C}_{s}}{{J}_{p} {i}^{2}} - \frac{{C}_{s}}{{J}_{v}} ] , \\ {B}_{1} = [ \begin{matrix}\frac{1}{{J}_{p}} & 0 \\ 0 & - \frac{1}{{J}_{v}}\end{matrix} ] , {B}_{2} = [ \begin{matrix}\frac{{C}_{s}}{{J}_{p} i} & \frac{{C}_{s}}{{J}_{v}}\end{matrix} ] ; \\ \text{?} \text{indicates text missing or illegible when filed}$$

I is a unit matrix;

the driving system is divided into two subsystems Λ₁ and Λ₂; the two subsystems Λ₁ and Λ₂ are mutually coupled; a state equation of the subsystem Λ₁ is:

$$\{ \begin{matrix}{\dot{x}}_{1} = {A}_{11} {x}_{1} + {A}_{12} {x}_{2} + {B}_{1} u \\ y = {x}_{1}\end{matrix}$$

a state equation of the subsystem Λ₂ is:

X₂=A₂₁x₁+A₂₂x₂+B₂u

the system state x₂=[Tₛ] of the subsystem Λ₂ is reconstructed; the input and the output of the system state x₂ respectively are:

$$\{ \begin{matrix}{u}_{oblu} = {A}_{21} {x}_{1} + {B}_{2} u \\ {y}_{oblu} = {\dot{x}}_{1} - {A}_{11} {x}_{1} - {B}_{1} u\end{matrix} ;$$

an output error feedback item G(y−ŷ) is introduced into the state equation of the subsystem Λ₂ to obtain an observer equation of the driving system as follows:

$${\dot{\hat{x}}}_{2} = {A}_{21} {x}_{1} + {A}_{22} {x}_{2} + {B}_{2} u + G ( y - \hat{y} ) = ( {A}_{22} - {GA}_{12} ) {\hat{x}}_{2} + {u}_{oblu} + {Gy}_{oblu}$$

wherein G is a feedback gain matrix; G=[g₁g₂]; g₁ is a feedback gain of the two measurable state variables; g₂ is a feedback gain of the state variable Tₛ.

Further, in step 3, transformation ŵ=\hat{x}₁−Gy is introduced into the rewritten observer equation of the driving system to obtain an expression equation and an error equation of the Luenberger observer as follows:

$$\{ \begin{matrix}\begin{matrix}\dot{\hat{w}} = ( \frac{\text{?}}{i} - \frac{\text{?}}{{J}_{p} i} - \frac{\text{?}}{{J}_{p}} ) {x}_{1} + ( \frac{{C}_{s} {C}_{v}}{{J}_{v}} - {k}_{s} + \frac{{C}_{v} {g}_{2}}{{J}_{v}} ) {x}_{2} + \\ ( - \frac{\text{?}}{{J}_{p} {i}^{2}} - \frac{\text{?}}{{J}_{v}} + \frac{{g}_{1}}{{J}_{p} i} - \frac{{g}_{2}}{{J}_{v}} ) {\hat{x}}_{3} + ( \frac{\text{?}}{{J}_{p} i} - \frac{{g}_{1}}{{J}_{p}} ) \text{?} + ( \frac{\text{?}}{{J}_{v}} + \frac{{g}_{2}}{{J}_{v}} ) {T}_{v}\end{matrix} \\ {\hat{x}}_{3} = w + {g}_{1} {x}_{1} + {g}_{2} {x}_{2}\end{matrix} \\ {\dot{\hat{x}}}_{3} = ( - \frac{\text{?}}{{J}_{p} {i}^{2}} - \text{?} ) {\hat{x}}_{3} \\ \text{?} \text{indicates text missing or illegible when filed}$$

The present invention has the following beneficial effects: the present invention feeds back the observer by utilizing the practical measurable information during vehicle running so as to reduce an error between an estimation result and an actual value. The present invention reconstructs the state of the driving system such that the state of the driving system has excellent observability. Additionally, the present invention introduces the transformation to reduce influence of integration on an observation result. Therefore, implementation difficulty of the observer is reduced, an observation error is reduced, and application in practice is achieved.

### BRIEF DESCRIPTION OF THE DRAWINGS

To describe the technical solutions in the embodiments of the present invention or the prior art more clearly, the following briefly introduces the accompanying drawings required for describing the embodiments or the prior art. Apparently, the accompanying drawings in the following description show merely some embodiments in the present invention, and a person of ordinary skill in the art may still derive other drawings from these accompanying drawings without creative efforts.

FIG. 1 is a block diagram of a linear Luenberger observer.

### DESCRIPTION OF THE PREFERRED EMBODIMENTS

The following clearly and completely describes the technical solutions in the embodiments of the present invention with reference to accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

A hybrid vehicle has three power sources, namely an engine, an electric motor A and an electric motor B. The engine and the electric motor A are coupled to drive front wheels of a vehicle. The electric motor B is used for driving rear wheels of the vehicle. Power batteries are electrically connected with the electric motor A and the electric motor B. An external force acted on the vehicle during straight running mainly comprises a traction force, a rolling resistance, an air resistance, a grade resistance, an acceleration resistance and the like. If such external force is transformed into a moment of force acted on the vehicle, a kinetic equation of the driving system is shown as follows:

$$\{ \begin{matrix}{J}_{P} {\ddot{θ}}_{B} = {T}_{P} - {C}_{i} {\dot{θ}}_{B} - \frac{1}{\text{?}} {T}_{s} \\ {J}_{v} {\ddot{θ}}_{v} = {T}_{s} - {C}_{v} {\dot{θ}}_{v} - {T}_{v} \\ {T}_{s} = {C}_{s} ( \frac{{\dot{θ}}_{B}}{\text{?}} - {\dot{θ}}_{v} ) + {k}_{s} ( \frac{{θ}_{B}}{{i}_{r}} - {θ}_{v} )\end{matrix} \\ \text{?} \text{indicates text missing or illegible when filed}$$

wherein \dot{θ}_{B} is a rotation angle of the electric motor B; \dot{θ}ᵥ is a rotation angle of a vehicle wheel; θ_{B} is a rotational speed of the electric motor; θᵥ is a rotational speed of the vehicle wheel; \dot{θ}_{B} and \dot{θ}ᵥ are obtained by conducting integration on the rotational speeds θ_{B} and θᵥ; J_{P} is an inertia of a rotor of the electric motor B; T_{P} is a torque of an output shaft of a driving system; Cₜ is a damping of a speed reducer; iᵣ is a transmission ratio of a main speed reducer; Jᵥ is the sum of an inertia of the vehicle wheel and an equivalent inertia equivalent from a vehicle body to the vehicle wheel; Cᵥ is a damping of the vehicle wheel; Cₛ is a damping of the drive shaft; kₛ is a rigidity of the drive shaft; Tᵥ is a moment of resistance of the vehicle; based on this, a state observer is built for the torque Tₛ of the driving shaft to observe, wherein \ddot{θ}_{B} is a rotation angle acceleration of the electric motor B, and \ddot{θ}ᵥ is a rotation angle acceleration of the vehicle wheel.

A method for constructing linear luenberger observer for vehicle control comprises the following steps:

step 1: building a state-space equation of a driving system of a vehicle to judge observability of the driving system;

wherein a state equation of the driving system is built by utilizing \dot{θ}_{B}, \dot{θ}ᵥ and Tₛ as state variables, \dot{θ}_{B} and \dot{θ}ᵥ as the output of the driving system, and T_{P} and Tᵥ as the input of the driving system; the state-space equation of the driving system is shown in equation (1):

$$\{ \begin{matrix}\hat{x} = Ax + Bu \\ y = Cx\end{matrix} \\ wherein x = [ \begin{matrix}\text{?} \\ \text{?} \\ \text{?}\end{matrix} ] , \\ A = [ \begin{matrix}- \frac{\text{?}}{{J}_{P}} & 0 & - \frac{1}{{J}_{p} {i}_{v}} \\ 0 & - \frac{{C}_{v}}{{J}_{v}} & \frac{1}{{J}_{v}} \\ \frac{\text{?}}{\text{?}} - \frac{\text{?}}{\text{?}} & \frac{{C}_{s} {C}_{v}}{{J}_{v}} - \text{?} & - \frac{\text{?}}{{J}_{p} {i}_{r}^{2}} - \frac{\text{?}}{{J}_{v}}\end{matrix} ] , \\ B = [ \begin{matrix}\frac{1}{{J}_{p}} & 0 \\ 0 & - \frac{1}{{J}_{v}} \\ \frac{\text{?}}{{J}_{p} i} & \frac{\text{?}}{{J}_{v}}\end{matrix} ] , C = [ \begin{matrix}1 & 0 & 0 \\ 0 & 1 & 0\end{matrix} ] , u = [ \begin{matrix}\text{?} \\ {T}_{v}\end{matrix} ] ; \\ \text{?} \text{indicates text missing or illegible when filed} \qquad ( 1 )$$

i is a transmission ratio of the main speed reducer, x is the input of the state-space equation, and y is the output of the state-space equation; therefore, an observability matrix of the driving system is

$$N = [ \begin{matrix}C \\ CA \\ {CA}^{2}\end{matrix} ] ;$$

equation (1) is substituted into the observability matrix to obtain:

$$N = [ \begin{matrix}1 & 0 & 0 \\ 0 & 1 & 0 \\ - \frac{{C}_{i}}{{J}_{p}} & 0 & - \frac{1}{{J}_{p} i} \\ 0 & - \frac{{C}_{v}}{{J}_{v}} & \frac{1}{{J}_{v}} \\ \begin{matrix}\frac{\text{?}}{{J}_{p}^{2}} - \\ \frac{1}{{J}_{p} i} ( \frac{\text{?}}{i} - \frac{{C}_{s} {C}_{i}}{{J}_{p} i} )\end{matrix} & - \frac{1}{{J}_{p} i} ( \frac{{C}_{s} {C}_{v}}{{J}_{v}} - \text{?} ) & \begin{matrix}\frac{{C}_{i}}{{J}_{p}^{2} i} + \\ \frac{1}{{J}_{p} i} ( \frac{\text{?}}{{J}_{p} {i}^{2}} + \frac{{C}_{s}}{{J}_{v}} )\end{matrix} \\ \frac{1}{{J}_{v}} ( \frac{{k}_{s}}{i} - \frac{{C}_{s} {C}_{i}}{{J}_{p} i} ) & \frac{{C}_{v}^{2}}{{J}_{v}^{2}} + \frac{1}{{J}_{v}} ( \frac{{C}_{s} {C}_{v}}{{J}_{v}} - {k}_{s} ) & \begin{matrix}- \frac{{C}_{v}}{{J}_{v}^{2}} - \\ \frac{1}{{J}_{v}} ( \frac{{C}_{s}}{{J}_{p} {i}^{2}} + \frac{\text{?}}{{J}_{v}} )\end{matrix}\end{matrix} ]$$

$$\text{?} \text{indicates text missing or illegible when filed}$$

a rank (N) of the observability matrix of the driving system is 3, so the driving system is observable;

step 2: dividing the state of the driving system into blocks according to the state-space equation of the driving system, and reconstructing state components of the driving system to obtain a rewritten observer equation of the driving system;

the state variables \dot{θ}_{B} and \dot{θ}ᵥ can be directly obtained through measurement, so, only a one-dimension dimension-reduction observer needs to be built to reconstruct Tₛ to build a system with excellent dynamic property, strong robustness and operation stability, thereby improving the observability of the system;

the two measurable state variables are the output of the driving system: y=x₁=[\dot{θ}_{B} \dot{θ}ᵥ]^{T}; the state variable Tₛ needs to be observed and is recorded as x₂=[Tₛ]; because the rank (C) is 2, the state of the torque of the drive shaft of the driving system is divided into the blocks, so the driving system can be rewritten to be:

$$\{ \begin{matrix}A = [ \begin{matrix}{A}_{11} & {A}_{12} \\ {A}_{21} & {A}_{22}\end{matrix} ] \\ B = [ \begin{matrix}{B}_{1} \\ {B}_{2}\end{matrix} ] \\ C = [ I 0 ] \end{matrix} \\ {A}_{11} = [ \begin{matrix}- \frac{{C}_{l}}{{J}_{p}} & 0 \\ 0 & - \frac{{C}_{v}}{{J}_{v}}\end{matrix} ] , {A}_{12} = [ \begin{matrix}- \frac{1}{{J}_{P} i} \\ \frac{1}{{J}_{v}}\end{matrix} ] , \\ wherein \\ {A}_{21} = [ \frac{{k}_{s}}{i} - \frac{{C}_{s} {C}_{t}}{{J}_{P} i} \frac{{C}_{s} {C}_{v}}{{J}_{v}} - {k}_{s} ] , \\ {A}_{22} = [ - \frac{{C}_{s}}{{J}_{P} {i}^{2}} - \frac{{C}_{s}}{{J}_{v}} ] , {B}_{1} = [ \begin{matrix}\frac{1}{{J}_{P}} & 0 \\ 0 & - \frac{1}{{J}_{v}}\end{matrix} ] , \\ {B}_{2} = [ \frac{{C}_{s}}{{J}_{P} {i}^{2}} \frac{{C}_{s}}{{J}_{v}} ] ;$$

I is a unit matrix;

the rewritten state-space equation of the driving system is:

$$\{ \begin{matrix}[ \begin{matrix}{\dot{x}}_{1} \\ {\dot{x}}_{2}\end{matrix} ] = [ \begin{matrix}{A}_{11} & {A}_{12} \\ {A}_{21} & {A}_{22}\end{matrix} ] [ \begin{matrix}{x}_{1} \\ {x}_{2}\end{matrix} ] + [ \begin{matrix}{B}_{1} \\ {B}_{2}\end{matrix} ] u \\ y = [ I 0 ] [ \begin{matrix}{x}_{1} \\ {x}_{2}\end{matrix} ] = {x}_{1} \end{matrix}$$

according to the state-space equation of the driving system, the driving system is divided into two subsystems Λ₁ and Λ₂; the two subsystems Λ₁ and Λ₂ are mutually coupled; a state equation of the subsystem Λ₁ is:

$$\{ \begin{matrix}{\dot{x}}_{1} = {A}_{11} {x}_{1} + {A}_{12} {x}_{2} + {B}_{1} u \\ y = {x}_{1} \end{matrix}$$

a state equation of the subsystem Λ₂ is:

X₂=A₂₁x₁+A₂₂x₂+B₂u

the system state x₂=[Tₛ] of the subsystem Λ₂ is reconstructed; the input and the output of the system state x₂ respectively are:

$$\{ \begin{matrix}{u}_{oblu} = {A}_{21} {x}_{1} + {B}_{2} u \\ {y}_{oblu} = {\dot{x}}_{1} - {A}_{11} {x}_{1} - {B}_{1} u\end{matrix}$$

an output error feedback item G(y−ŷ) is introduced into the state equation of the subsystem Λ₂, wherein G is a feedback gain matrix; G=[g₁g₂], g₁ is a feedback gain of two measurable state variables; g₂ is a feedback gain of the state variable Tₛ; so the observer equation of the driving system is obtained:

$$\begin{matrix}{\dot{\hat{x}}}_{2} = {A}_{21} {x}_{1} + {A}_{22} {x}_{2} + {B}_{2} u + G ( y - \hat{y} ) \\ = ( {A}_{22} - {GA}_{12} ) {\hat{x}}_{2} + {u}_{oblu} + {Gy}_{oblu}\end{matrix}$$

step 3: introducing transformation into the rewritten state equation of the driving system to correct the state equation of the driving system, thereby obtaining an equation and a structure of the linear Luenberger observer;

because the rewritten observer equation of the driving system has a differential of an output quantity y of the driving system, the implementation difficulty of state variable observation is increased. Additionally, high-frequency noise in an output signal of a rotational speed sensor is also amplified such that an observation error is increased. To eliminate influence of the differential on the observation result, transformation is introduced into the rewritten observer equation of the driving system ŵ=\hat{x}₁−Gy;

the rewritten observer equation of the driving system is transformed to be:

$$\{ \begin{matrix}\dot{\hat{w}} = ( {A}_{22} - {GA}_{12} ) {\hat{x}}_{2} + ( {A}_{21} - {GA}_{11} ) y + ( {B}_{2} - {GB}_{1} ) u \\ {\hat{x}}_{2} = \hat{w} + Gy \end{matrix}$$

observation of the torque Tₛ of the drive shaft is achieved by the observer equation of the driving system in step 3;

a state estimation error equation of the driving system is:

\dot{\tilde{x}}₂=x₂−\dot{\hat{x}}₂=(A₂₂−GA₁₂)\tilde{x}₂

a pole of (A₂₂−GA₁₂) is configured by utilizing a pole configuration method such that the estimation error \tilde{x}₂ is quickly attenuated to be zero, thereby helping the estimation error \tilde{x}₂ to quickly attenuate to be zero; the state-space equation of the driving system is substituted into the above equation to obtain an equation and a state observation error expression of the linear Luenberger observer to be:

$$\{ \begin{matrix}\dot{\hat{w}} = ( \frac{{k}_{s}}{i} - \frac{{C}_{s} {C}_{l}}{{J}_{P} i} - \frac{{C}_{l} {g}_{1}}{{J}_{P}} ) {x}_{1} + ( \frac{{C}_{s} {C}_{v}}{{J}_{v}} - {k}_{s} + \frac{{C}_{v} {g}_{2}}{{J}_{v}} ) {x}_{2} + \\ ( - \frac{{C}_{d}}{{J}_{P} {i}^{2}} - \frac{{C}_{s}}{{J}_{v}} + \frac{{g}_{1}}{{J}_{P} i} - \frac{{g}_{2}}{{J}_{v}} ) {\hat{x}}_{3} + ( \frac{{C}_{s}}{{J}_{P} i} - \frac{{g}_{1}}{{J}_{P}} ) {T}_{s} + ( \frac{{C}_{s}}{{J}_{v}} + \frac{{g}_{2}}{{J}_{v}} ) {T}_{v} \\ {\hat{x}}_{3} = \hat{w} + {g}_{1} {x}_{1} + {g}_{2} {x}_{2} \end{matrix} \\ {\dot{\tilde{x}}}_{3} = ( - \frac{{C}_{s}}{{J}_{P} {i}^{2}} - \frac{{C}_{s}}{{J}_{v}} + \frac{{g}_{1}}{{J}_{P} i} - \frac{{g}_{2}}{{J}_{v}} ) {\tilde{x}}_{3} \\ wherein x = [ \begin{matrix}{x}_{1} \\ {x}_{2} \\ {x}_{3}\end{matrix} ] = [ \begin{matrix}{\dot{θ}}_{B} \\ {\dot{θ}}_{v} \\ {T}_{s}\end{matrix} ] ;$$

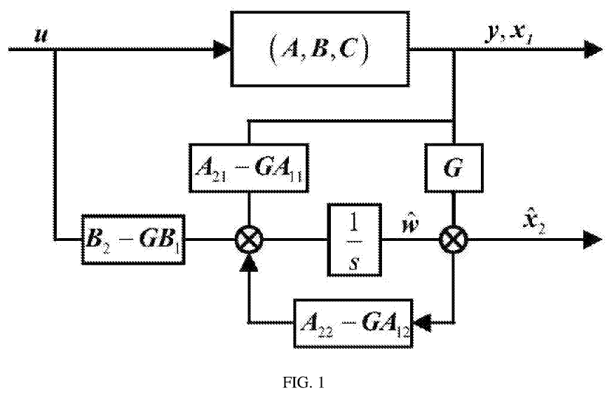

the design of the linear Luenberger observer is completed. The structure of the linear Luenberger observer is shown in FIG. 1.

Each embodiment of the present specification is described in a correlative manner, the same and similar parts between the embodiments may refer to each other, and each embodiment focuses on the difference from other embodiments. For a system disclosed in the embodiments, since it is basically similar to the method disclosed in the embodiments, the description is relatively simple, and reference can be made to the method description.

The above merely describes preferred embodiments of the present invention, but are not used to limit the protection scope of the present invention. Any modifications, equivalent substitutions, improvements, and the like within the spirit and principles of the invention are intended to be included within the protection scope of the present invention.

1. A method for constructing linear Luenberger observer for vehicle control, specifically comprising the following steps:
step 1: building a state-space equation of a driving system of a vehicle to judge observability of the driving system;
wherein a state equation of the driving system is built by utilizing \dot{θ}_{B}, \dot{θ}ᵥ and Tₛ as state variables, \dot{θ}_{B} and \dot{θ}ᵥ as the output of the driving system, and T_{P} and Tᵥ as the input of the driving system; the state-space equation of the driving system is shown in equation (1):
$$\{ \begin{matrix}\dot{x} = Ax + Bu \\ y = Cx \end{matrix} \qquad ( 1 )$$
wherein x is the input of the state-space equation; y is the output of the state-space equation;
$$x = [ \begin{matrix}{\dot{θ}}_{B} \\ {\dot{θ}}_{v} \\ {T}_{s}\end{matrix} ] , A = [ \begin{matrix}- \frac{{C}_{l}}{{J}_{P}} & 0 & - \frac{1}{{J}_{P} {i}_{r}} \\ 0 & - \frac{{C}_{v}}{{J}_{v}} & \frac{1}{{J}_{v}} \\ \frac{{k}_{s}}{{i}_{r}} - \frac{{C}_{s} {C}_{l}}{{J}_{P} {i}_{r}} & \frac{{C}_{s} {C}_{v}}{{J}_{v}} - {k}_{s} & - \frac{{C}_{s}}{{J}_{P} {i}_{r}^{2}} - \frac{{C}_{s}}{{J}_{v}}\end{matrix} ] , \\ B = [ \begin{matrix}\frac{1}{{J}_{P}} & 0 \\ 0 & - \frac{1}{{J}_{v}} \\ \frac{{C}_{s}}{{J}_{P} i} & \frac{{C}_{s}}{{J}_{v}}\end{matrix} ] , C = [ \begin{matrix}1 & 0 & 0 \\ 0 & 1 & 0\end{matrix} ] , u = [ \begin{matrix}{T}_{P} \\ {T}_{v}\end{matrix} ] ;$$
\dot{θ}_{B} is a rotation angle of an electric motor B; \dot{θ}ᵥ is a rotation angle of a vehicle wheel; θ_{B} is a rotational speed of the electric motor; θᵥ is a rotational speed of the vehicle wheel; \dot{θ}_{B} and \dot{θ}ᵥ are obtained by conducting integration on the rotational speeds θ_{B} and θᵥ; Tₛ is a torque of a drive shaft; Cₜ is a damping of a speed reducer; J_{P} is an inertia of a rotor of the electric motor B; iᵣ is a main speed reducer transmission ratio; Cᵥ is a damping of the vehicle wheel; Jᵥ is the sum of an inertia of the vehicle wheel and an equivalent inertia equivalent from a vehicle body to the vehicle wheel; kₛ is a rigidity of the drive shaft; Cₛ is a damping of the drive shaft; i is a transmission ratio of a main speed reducer; T_{P} is a torque of an output shaft of the driving system; Tᵥ is a moment of resistance of a vehicle;
an observability matrix of the driving system is
$$N = [ \begin{matrix}C \\ CA \\ {CA}^{2}\end{matrix} ] ;$$
when a rank of the observability matrix N is 3, the driving system is observable;
step 2: dividing the state of the driving system into blocks, and reconstructing state components of the driving system to obtain a rewritten state observation equation of the driving system;
step 3: introducing transformation into the rewritten state equation of the driving system to obtain an expression equation and an error equation of the Luenberger observer.

2. The method for constructing linear luenberger observer for vehicle control according to claim 1, wherein step 2 specifically comprises the following steps:
the two measurable state variables are the output of the driving system: y=x₁=[\dot{θ}_{B} \dot{θ}ᵥ]^{T}; the state variable Tₛ needs to be observed and is recorded as x₂=[Tₛ]; because the rank of a matrix C is 2, the state-space equation of the driving system is rewritten to be:
$$\{ \begin{matrix}[ \begin{matrix}{\dot{x}}_{1} \\ {\dot{x}}_{2}\end{matrix} ] = [ \begin{matrix}{A}_{11} & {A}_{12} \\ {A}_{21} & {A}_{22}\end{matrix} ] [ \begin{matrix}{x}_{1} \\ {x}_{2}\end{matrix} ] + [ \begin{matrix}{B}_{1} \\ {B}_{2}\end{matrix} ] u \\ y = [ I 0 ] [ \begin{matrix}{x}_{1} \\ {x}_{2}\end{matrix} ] = {x}_{1} \end{matrix} \\ {A}_{11} = [ \begin{matrix}- \frac{{C}_{l}}{{J}_{p}} & 0 \\ 0 & - \frac{{C}_{v}}{{J}_{v}}\end{matrix} ] , {A}_{12} = [ \begin{matrix}- \frac{1}{{J}_{P} i} \\ \frac{1}{{J}_{v}}\end{matrix} ] , \\ wherein \\ {A}_{21} = [ \frac{{k}_{s}}{i} - \frac{{C}_{s} {C}_{t}}{{J}_{P} i} \frac{{C}_{s} {C}_{v}}{{J}_{v}} - {k}_{s} ] , {A}_{22} = [ - \frac{{C}_{s}}{{J}_{P} {i}^{2}} - \frac{{C}_{s}}{{J}_{v}} ] , \\ {B}_{1} = [ \begin{matrix}\frac{1}{{J}_{P}} & 0 \\ 0 & - \frac{1}{{J}_{v}}\end{matrix} ] , {B}_{2} = [ \frac{{C}_{s}}{{J}_{P} i} \frac{{C}_{s}}{{J}_{v}} ] ;$$
I is a unit matrix;
the driving system is divided into two subsystems Λ₁ and Λ₂; the two subsystems Λ₁ and Λ₂ are mutually coupled; a state equation of the subsystem Λ₁ is:
$$\{ \begin{matrix}{\dot{x}}_{1} = {A}_{11} {x}_{1} + {A}_{12} {x}_{2} + {B}_{1} u \\ y = {x}_{1} \end{matrix}$$
a state equation of the subsystem Λ₂ is:
X₂=A₂₁x₁+A₂₂x₂+B₂u
the system state x₂=[Tₛ] of the subsystem Λ₂ is reconstructed; the input and the output of the system state x₂ respectively are:
$$\{ \begin{matrix}{u}_{oblu} = {A}_{21} {x}_{1} + {B}_{2} u \\ {y}_{oblu} = {\dot{x}}_{1} - {A}_{11} {x}_{1} - {B}_{1} u\end{matrix} ;$$
an output error feedback item G(y−ŷ) is introduced into the state equation of the subsystem Λ₂ to obtain an observer equation of the driving system as follows:
$$\begin{matrix}{\dot{\hat{x}}}_{2} = {A}_{21} {x}_{1} + {A}_{22} {x}_{2} + {B}_{2} u + G ( y - \hat{y} ) \\ = ( {A}_{22} - {GA}_{12} ) {\hat{x}}_{2} + {u}_{oblu} + {Gy}_{oblu}\end{matrix}$$
wherein G is a feedback gain matrix; G=[g₁g₂]; g₁ is a feedback gain of the two measurable state variables; g₂ is a feedback gain of the state variable Tₛ.

3. The method for constructing linear luenberger observer for vehicle control according to claim 1, wherein in step 3, transformation ŵ=\hat{x}₁−Gy is introduced into the rewritten observer equation of the driving system to obtain an expression equation and an error equation of the Luenberger observer as follows:
$$\{ \begin{matrix}\dot{\hat{w}} = ( \frac{{k}_{s}}{i} - \frac{{C}_{s} {C}_{l}}{{J}_{P} i} - \frac{{C}_{l} {g}_{1}}{{J}_{P}} ) {x}_{1} + ( \frac{{C}_{s} {C}_{v}}{{J}_{v}} - {k}_{s} + \frac{{C}_{v} {g}_{2}}{{J}_{v}} ) {x}_{2} + \\ ( - \frac{{C}_{d}}{{J}_{P} {i}^{2}} - \frac{{C}_{s}}{{J}_{v}} + \frac{{g}_{1}}{{J}_{P} i} - \frac{{g}_{2}}{{J}_{v}} ) {\hat{x}}_{3} + ( \frac{{C}_{s}}{{J}_{P} i} - \frac{{g}_{1}}{{J}_{P}} ) {T}_{s} + ( \frac{{C}_{s}}{{J}_{v}} + \frac{{g}_{2}}{{J}_{v}} ) {T}_{v} \\ {\hat{x}}_{3} = \hat{w} + {g}_{1} {x}_{1} + {g}_{2} {x}_{2} \end{matrix} \\ {\dot{\tilde{x}}}_{3} = ( - \frac{{C}_{s}}{{J}_{P} {i}^{2}} - \frac{{C}_{s}}{{J}_{v}} + \frac{{g}_{1}}{{J}_{P} i} - \frac{{g}_{2}}{{J}_{v}} ) {\tilde{x}}_{3} .$$
